(19) United States
(12) Patent Application Publication
(10) Pub. No.: US 2005/0287261 A1
(43) Pub. Date: Dec. 29, 2005

(54) Garlic freshness preservation by small vacuum pack

(76) Inventors: Rick M. Zhou, Hacienda Heights, CA (US); Frank Xiao Yang Zhou, Hacienda Heights, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/924,478

(22) Filed: Aug. 23, 2004

(30) Foreign Application Priority Data
Feb. 10, 2004 (CN) 200410058336.X

(51) Int. Cl. A23L 3/00

(52) U.S. Cl. 426/404

(57) ABSTRACT

A method for preserving the freshness of garlic cloves using vacuum packs thereby extending the retail shelf life from one month to three months. Each garlic clove is cut at the root of the clove and sealed within a small vacuum bag consisting of one or more separated cloves. A plurality of the small vacuum bags are placed within an outer container stored within normal fresh vegetable conditions. Preferably, three to four cloves in one bag provide one day's consumption, and multiple bags are stored in one pack or jar container. Since the cloves are separated within the small bags, the garlic smell is eliminated and there is no cross-contamination from other cloves. Also, since the cloves are sealed in a fixed position they are aesthetically pleasing and will not endure any surface damage during transportation.

### FIELD OF THE INVENTION

The present invention relates to a method for improving the retail shelf life of garlic cloves by the use of vacuum packaging. The method provides for enhanced freshness of garlic gloves and convenience in serving size.

### BACKGROUND ART

Typically, garlic cloves begin to decay or grow mold after only a few weeks of storage. Retailers are forced to remove and discard unsold cloves from the shelf, therefore sustaining financial losses. Customers enjoy freshness of garlic cloves for as long as the shelf life indicates and are forced to either use the cloves hurriedly or discard spoiled cloves after only a few weeks of purchase.

In recent times, further preservation of the shelf life has been accomplished by adding chemical preservatives to the garlic cloves, by packing the cloves in a jar, or storing the garlic cloves at low temperatures. The maximum shelf life of cloves is currently about one to two months, depending on the freshness of the garlic at the beginning of storage.

Though the chemical preservation method enhances shelf life for retailers, it is not a preferred or healthy solution for consumers. Typically, large quantities of cloves, ranging from one to five pounds, are stored in a single jar or pack. This storage solution causes much bacteria and cross-contamination from other cloves. When a single clove in a jar begins to decay or grow old, it affects and speeds other cloves' decay and the odor of non-freshness of garlic becomes very strong. In addition, the free movement of the cloves in such a large bag or jar causes much cross-surface damage on the garlic cloves. In such prior methods, garlic cloves are susceptible to contamination by foreign materials such as hair, root plates, ants, etc. Therefore, there is a need for vacuum packaging garlic cloves in deliberately separated and fixed position so as to prevent the problems associated with damage, bacteria growth, and odors, and thus increase the shelf life of garlic. There is also a need to package garlic cloves in smaller packs to improve convenience in cooking, for instance, eliminating the need to reseal packaging of unused portions, and further improve presentation of packaging.

### SUMMARY OF THE INVENTION

Accordingly, the present invention has been made keeping in mind the above problems of the prior art including that associated with the retailer and the consumer, and an object of the present invention is to provide garlic cloves with prolonged freshness by vacuum packing, thereby extending the shelf life of garlic cloves.

In accordance with one aspect of the present invention, the method of extending shelf life of garlic cloves comprises peeling the skin portion of the garlic cloves, cutting the bottom root portion of the garlic cloves; separating and vacuum sealing a plurality of garlic cloves, in a small vacuum bag. The cloves are separated such that space exists between the cloves after the vacuum sealing process. Preferably, three to four of the garlic cloves, which is equivalent to an average one day's garlic consumption of an average household, is vacuum packed in a small bag. Ideally, less than ten cloves are packed in a single bag. A single bag can hold a small amount such as one or two cloves to accommodate a single person's cooking needs. For reasons such as storage or distribution, a plurality of the small vacuumed bags of cloves, preferably seven to ten bags are placed in a zipper bag or jar or other comparable storage apparatus. The bags of garlic gloves are stored in normal conditions as other fresh vegetables or preferably between the temperature of about of −1° to about 4° C.

In another embodiment of the present invention, the garlic cloves are unpeeled or remain with skin prior to vacuum packaging.

In other embodiments, the garlic cloves are spaced apart substantially evenly and positioned in symmetrical orientation.

In yet another embodiment of the present invention, ten to seventy small vacuum bags are stored in the outer container depending on the customer needs.

These and other embodiments of the present invention are further made apparent, in the remainder of the present document, to those of ordinary skill in the art.

### BRIEF DESCRIPTION OF THE DRAWINGS

Features, aspects and advantages of some embodiments of the present invention will become better understood with reference to the accompanying drawings, which are not to be considered limitations in the scope of the invention, but are merely illustrative.

FIG. 1 shows a small vacuum bag packaging nine garlic cloves according to an embodiment of the present invention.

FIG. 2 shows a small vacuum bag packaging four garlic cloves according to an embodiment of the present invention.

FIG. 3 shows an enlarged view of a single garlic clove as shown in FIG. 1 and FIG. 2, cut at its root.

FIG. 4 shows ajar outer container containing a plurality of small vacuum bags of garlic cloves according to an embodiment of the present invention.

FIG. 5 shows a zipper outer container containing a plurality of small vacuum bags of garlic cloves according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

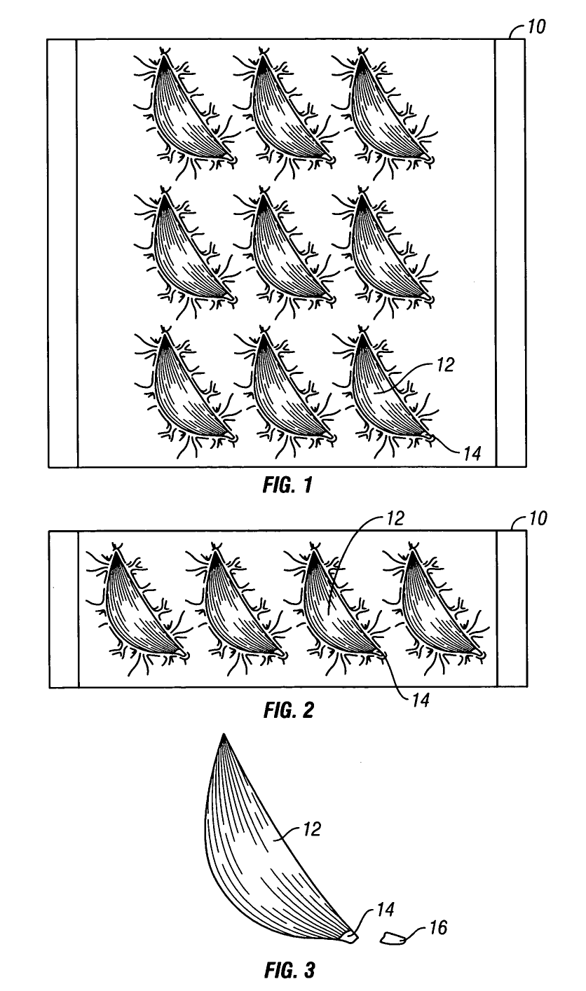

As shown in FIG. 1, a small vacuum bag 10 comprises one or more garlic cloves 12, (in the embodiment shown, nine cloves) each clove being cut at its root 14. The small vacuum bag 10 seals the garlic cloves 12 in a fixed position and allows the garlic cloves 12 to be substantially evenly spaced apart, such that a clove does not touch another clove.

As shown in FIG. 2, a small vacuum bag 10 comprises four garlic cloves 12, each clove being cut at its root 14. In the preferred embodiment, three to four garlic cloves are vacuum sealed in a sturdy plastic bag or plastic packaging. The small vacuum bag 10 seals the garlic cloves 12 in a fixed position and allows the garlic cloves 12 to be substantially evenly spaced apart.

FIG. 3 is an enlarged view of the garlic clove 12 illustrating the cut at the root 14. The root 14 is cut from the cloves prior to packaging to eliminate the bacteria base 16 to be discarded.

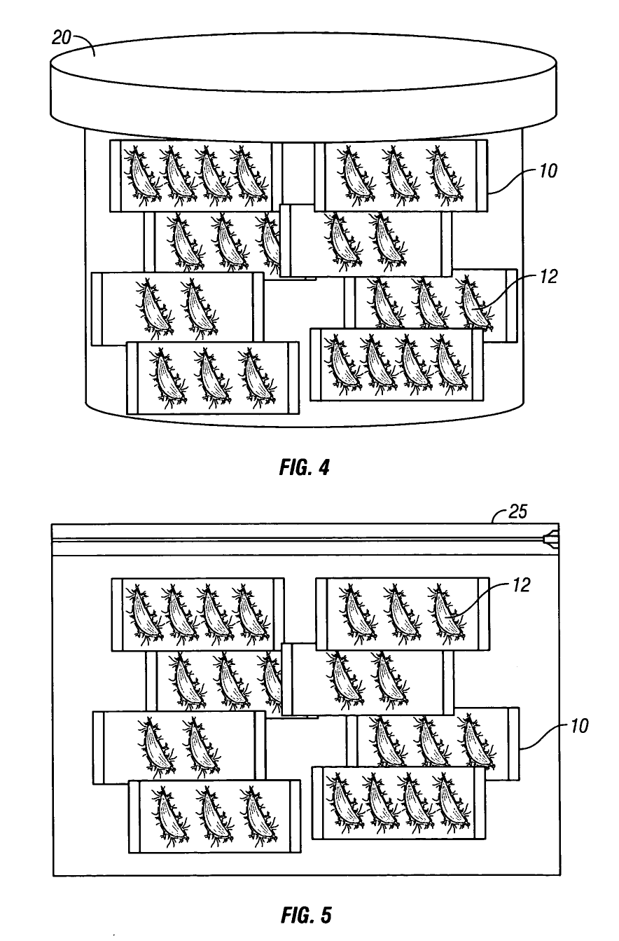

In FIG. 4, ajar outer container 20 for holding or storing a plurality of small vacuum bags 10 is shown, where each bag 10 contains one or more spaced apart cloves 12. In one embodiment of the present invention, seven to ten small vacuum bags 10 are stored in the outer container 20.

FIG. 5 illustrates a zipper outer container 25 consisting of a plurality of small vacuum bags 10, each bag containing one or more cloves 12. The zipper outer container 25 is preferably a plastic material zipper lock type bag. The jar or zipper outer containers 20, 25 do not need to be vacuumed as long as the small vacuum bags 10 are vacuum sealed. The small vacuum bags 10 are preferably stored in normal conditions of as other vegetables, for instance at temperatures of between about −1° to 4° C.

In the primary embodiment of the present invention the garlic cloves 12 are peeled. Peeled cloves allow for the convenience and ease in immediately using the cloves for cooking when peeled cloves are required. In another embodiment, the garlic cloves 12 are unpeeled and stored in the small vacuum bag 10 as unpeeled cloves.

One advantage of the present invention is that the vacuum bags 10 allow the garlic cloves 12 to be held in fixed and spaced apart position, therefore eliminating cross-contamination with other cloves. Bacteria is stored within the root 14 of the garlic clove, and by cutting the root the bacteria base 16 is eliminated. Also, the cloves 12 look more beautiful, i.e. damage free, due to the fixed position each clove 12 remains in when vacuum packed in a small vacuum bag 10 resulting in no movement among the cloves 12 to cause surface damage during transportation. The small vacuum bags 10 of cloves 12, eliminates the garlic smell that occurs in large bags consisting of many cloves bunched and overlapping together. The small amount of cloves 12 within a single small vacuum bag 10 is equivalent to an average family's one-day consumption so there is no need to reseal or re-vacuum.

Furthermore, the retail shelf life of the garlic cloves 12 will be improved from one month to three months (or 60 to 90 days).

Furthermore, not only does the present invention have the advantages of enhanced retail shelf life, odor reduction, and cost effectiveness, but it also creates a conveniently packaged and aesthetically pleasing product. The embodiments of the present invention are simple yet visually impressive.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

1. A method for vacuum packaging garlic cloves to improve shelf life comprising the steps of:
(a) cutting a plurality garlic cloves at the root of said cloves;
(b) placing one or more of said cloves in a vacuum bag, separated and spaced apart;
(c) vacuum sealing the cloves in the vacuum bag wherein said cloves remain in a fixed position;
(d) storing said vacuum bags at a normal temperature for storing vegetables;
wherein the shelf life of said cloves are improved from one month to three months.

2. The method for vacuum packaging garlic cloves as set forth in claim 1, further comprising peeling the garlic cloves before the cutting step.

3. The method for vacuum packaging garlic cloves as set forth in claim 1 wherein the normal temperature ranges between about −1° to 4° C.

4. The method for vacuum packaging garlic cloves as set forth in claim 1, further comprising preparing a plurality of said vacuum bags of cloves and placing said bags within an outer container.

5. The method for vacuum packaging garlic cloves as set forth in claim 2, further comprising preparing a plurality of said vacuum bags of cloves and placing said bags within an outer container.

6. The method for vacuum packaging garlic cloves as set forth in claim 4 comprising placing said seven to ten of said vacuum bags of cloves within an outer container.

7. The method for vacuum packaging as set forth in claim 4, wherein eleven to sixty vacuum bags are placed within outer container.

8. The method for vacuum packaging garlic cloves as set forth in claim 5 comprising placing said seven to ten of said vacuum bags of cloves within an outer container.

9. The method for vacuum packaging as set forth in claim 5, wherein eleven to sixty vacuum bags are placed within outer container.

10. The method for vacuum packaging as set forth in claim 4-9, wherein the outer container is a zipper bag.

11. The method for vacuum packaging as set forth in claim 4-9, wherein the outer container is ajar.

12. A vacuum pack of garlic cloves with an improved shelf life from one month to three months, comprising:
(a) peeled garlic cloves, wherein each clove is cut at the root of each clove;
(b) a vacuum bag holding one or more of said cloves, wherein the cloves are vacuum packed separated and spaced apart, and said cloves remain in a fixed position;
(c) an outside container holding a plurality of said vacuum bag.

13. The vacuum pack of garlic cloves as set forth in claim 12, wherein the garlic cloves are unpeeled.

14. The vacuum pack of garlic cloves as set forth in claim 12, wherein the vacuum bag holds three to four cloves.

15. The vacuum pack of garlic cloves as set forth in claim 12, wherein seven to ten vacuum bags are placed within outer container.

16. The vacuum pack of garlic cloves as set forth in claim 12, wherein eleven to sixty vacuum bags are placed within outer container.

17. The vacuum pack of garlic cloves as set forth in claim 12, wherein the outer container is a zipper bag.

18. The vacuum pack of garlic cloves as set forth in claim 12, wherein the outer container is ajar.

19. A method for vacuum packaging garlic cloves to improve shelf life comprising the steps of:
(a) cutting a plurality garlic cloves at the root of said cloves;
(b) providing three to four said cloves in a vacuum bag, separated and spaced apart;
(c) vacuum sealing said cloves within the vacuum bag wherein said cloves remain in a fixed position;
(d) placing a plurality of said vacuum bags in an outside container;
(e) storing said vacuum bags at a temperature of −1° to 4° C.;
wherein the shelf life of said cloves are improved from one to three months.

20. The method for vacuum packaging garlic cloves as set forth in claim 19, further comprising peeling the garlic cloves before the cutting step.

21. The method for vacuum packaging garlic cloves as set forth in claim 19, wherein seven to ten vacuum bags are placed within the outer container.

22. The method for vacuum packaging garlic cloves as set forth in claim 19, wherein eleven to sixty vacuum bags are placed within the outer container.

23. The method for vacuum packaging garlic cloves as set forth in claim 20, wherein seven to ten vacuum bags are placed within the outer container.

24. The method for vacuum packaging garlic cloves as set forth in claim 20, wherein eleven to sixty vacuum bags are placed within the outer container.

25. The method for vacuum packaging as set forth in claims 19 and 20, where the outer container is a zipper bag.

26. A method for vacuum packaging as set forth in claims 19 and 20, wherein the outer container is a jar.
